(19) United States
(12) Patent Application Publication
(10) Pub. No.: US 2004/0144716 A1
(43) Pub. Date: Jul. 29, 2004

(54) Filtering medium of oil filter for automatic transmission

(76) Inventors: Masaki Kobayashi, Moriyama-shi (JP); Hirokazu Suzuki, Hamakita-shi (JP)

Correspondence Address: Young & Thompson, Second Floor, 745 South 23rd Street, Arlington, VA, 22202, US

(21) Appl. No.: 10/475,973

(22) PCT Filed: Apr. 25, 2002
(86) PCT No.: PCT/JP02/04131

(30) Foreign Application Priority Data
Apr. 27, 2001 (JP) 2001-132223
Apr. 22, 2002 (JP) 2002-119726

(51) Int. Cl. B01D 39/16

(52) U.S. Cl. 210/508; 442/169

(57) ABSTRACT

A filter element (30) which has a filtering medium (31) formed by ruffling a fiber sheet and a resin frame (32) surrounding the perimeter of the filtering medium (31); and a filtering medium (31) which comprises a fiber sheet comprising a heat-resistant fiber having a melting temperature or a carbonization temperature of 300° C. or higher. As the heat-resistant fiber, use can be made of a meta-type or para-type wholly aromatic polyamide fiber, a wholly aromatic polyester fiber, a polyphenylene sulfide fiber, or a polyamideimide fiber. As a fiber constituting the fiber sheet except the heat-resistant fiber, use can be made of a fiber having a softening point of 150° C. or higher such as a polyamide based fiber, a polyester based fiber, an acrylic fiber, or a vinylon fiber. Preferably, the heat-resistant fiber accounts for 3 mass % or more of the fiber sheet The filtering medium is suppressed in the reduction of bursting strength during use and causes no substantial problems in practical use.

### TECHNICAL FIELD

The present invention relates to a filtering medium of an oil filter for automatic transmission. More particularly, the present invention relates to a practical filtering medium of an oil filter for automatic transmission which is less susceptible to a decrease in bursting strength.

### BACKGROUND ART

Automatic transmissions using torque converters have conventionally been used widely in vehicles, and a filter for constantly filtering oil is installed in an automatic transmission.

FIG. 5 is a schematic sectional view illustrating a conventional oil filter for automatic transmission disclosed, for example, in Japanese Unexamined Patent Publication No. 2000-2108. In FIG. 5, a filter 1 comprises a lower case 3 having an inlet port 2 on the bottom thereof, an upper case 5 having an outlet port 4 on the upper surface thereof, and a filtering medium 6 provided on a contact surface between the lower case 3 and the upper case 5. Oil flows from bottom upward from the inlet port 2 toward the outlet port 4. A filter case 7 is formed from the lower case 3 and the upper case 5. The contact surface between the lower case 3 and the upper case 5 inclines from the horizontal direction, and is provided on the diagonal of the filter case 7.

The lower case 3 has a cup shape having an opening upper surface, and a pressing face 8 for pressing the filtering medium 6 is formed on the peripheral edge thereof. This pressing face 8 is diagonally formed so as to incline from the horizontal direction. The lower case 5 has a cup shape having an opening lower surface, and a pressing face 10 for pressing the filtering medium 6 is formed on the peripheral edge thereof. This pressing face 10 is also diagonally formed so as to incline from the horizontal direction.

The filtering medium 6 comprises a metal net, a filter paper or the like, and is formed into a thin and flat shape. The filtering medium 6 is fitted into the inner periphery of a rising portion 9 of the lower case 3, and held between the pressing face 10 of the upper case 5 and the pressing face 8 of the lower case 3.

The filter 1 as described above is arranged in a state in which the inlet port 2 slightly floats from the bottom of a sump. When an oil pump is operated, lubricant oil is sucked from the inlet port 2, and the oil flows from bottom upward. The oil sucked into the filter case 7 passes through the filtering medium 6 while gradually changing the running direction thereof toward the horizontal direction. When oil passes through the filtering medium 6, dust contained in the oil is removed. The oil from which dust has been removed, flows out from the outlet port 4 while changing again the running direction upward. The oil is then sent from the oil pump into the automatic transmission.

### DISCLOSURE OF INVENTION

As a filtering medium of an oil filter of automatic transmission of an automobile or the like, a felt-like non-woven fabric comprising nylon fiber, polyester fiber or the like, as disclosed in Japanese Unexamined Patent Application Publication No. 9-327609, is known. An automatic transmission of an automobile or the like, however, has a problem in that the filtering medium comprising the above-mentioned felt-like non-woven fabric has a bursting strength decreased because temperature of oil becomes higher as about 150° C. and the oil itself becomes acidic through oxidation pyrolysis, and as a result, the product becomes useless as a filtering medium.

The present invention was developed to solve such a conventional problem, and has an object to provide a filtering medium for an oil filter of automatic transmission which is low in the decrease in bursting strength and poses no problem in practice.

The present invention provides a filtering medium of an oil filter for automatic transmission, comprising a fiber sheet containing a heat-resistant fiber, of which the melting temperature or the carbonization temperature is at least 300° C.

In a preferred embodiment of the present invention, the fiber is wholly aromatic polyamide fiber.

In another preferred embodiment of the present invention, said fiber accounts for 3 mass % or more of the entire fibers constituting the fiber sheet.

In still another preferred embodiment of the present invention, the fiber sheet has a coarse/dense structure.

In further another preferred embodiment of the present invention, the fibers constituting the fiber sheet are bonded by at least a kind of binder selected from a group consisting of rubber-based binders, thermosetting binders, and thermoplastic binders.

In another preferred embodiment of the present invention, the above-mentioned fiber sheet has an area having a large deposit quantity of the binder and an area having a small deposit quantity of the binder.

According to the present invention, since the filtering medium comprises a fiber sheet containing a heat-resistant fiber, of which the melting temperature or the carbonization temperature is at least 300° C., the filtering medium can maintain a practical bursting strength.

According to a preferred embodiment of the present invention, since the above-mentioned fiber is wholly aromatic polyamide fiber, the strength is hardly reduced by an acid, and the fiber remains to be a suitable heat-resistant fiber, with a slighter decrease in bursting strength, thus giving a satisfactory filtering medium.

According to a preferred embodiment of the present invention, since the fiber accounts for 3 mass % or more of the. entire fibers constituting the fiber sheet, there is available a filtering medium of which the bursting strength is hardly decreased by heat.

According to a preferred embodiment of the present invention, since the fiber sheet has a coarse/dense structure, a filtering medium excellent in filtering property is obtained.

According to a preferred embodiment of the present invention, since fibers constituting the fiber sheet are bonded by at least a kind of binder selected from a group consisting of rubber-based binders, thermosetting binders, and thermoplastic binders, the fiber is not easily peeled off or deformed.

According to a preferred embodiment of the present invention, since the fiber sheet has an area having a large deposit quantity of the binder and an area having a small deposit quantity of the binder, a coarse/dense structure is formed, and the filtering property of the filtering medium is further improved.

### BRIEF DESCRIPTION OF THE DRAWINGS

FIG. 1 is a schematic side sectional view illustrating a filter unit to which the filtering medium of an oil filter for automatic transmission of an embodiment of the present invention is applied.

FIG. 2 is a schematic side sectional view illustrating another example of the filter unit and a filter element.

FIG. 3 is a schematic side sectional view illustrating still another example of the filter unit and the filter element.

FIG. 4 is a diagram illustrating the relationship between the ATF immersion time and the strength retaining ratio in Examples 1 to 4 and Comparative Examples 1 to 4.

FIG. 5 is a schematic view illustrating a typical conventional automatic transmission.

### BEST MODE FOR CARRYING OUT THE INVENTION

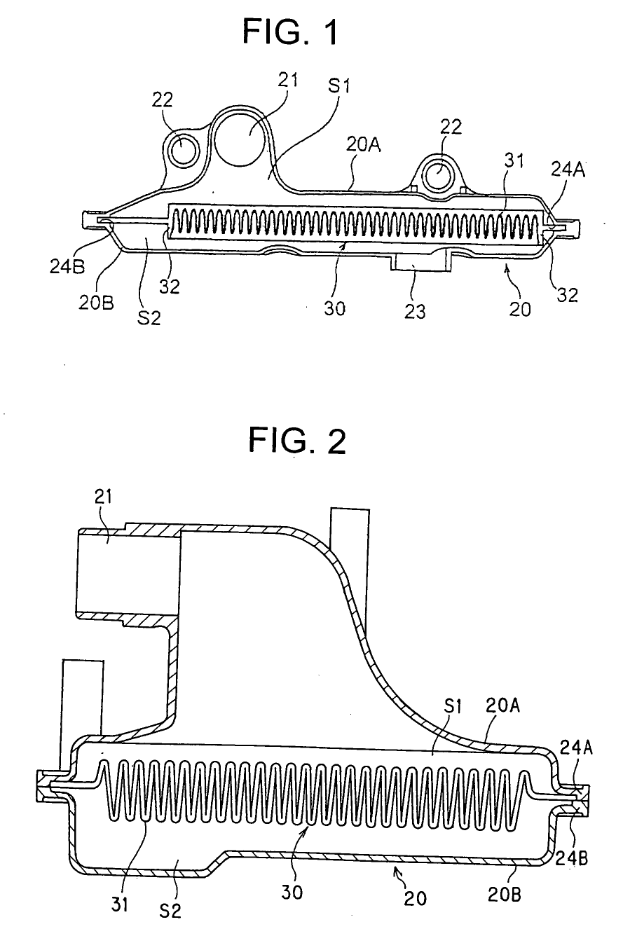

FIG. 1 is a schematic side sectional view illustrating a filter unit to which the filtering medium of an oil filter for automatic transmission of an embodiment of the present invention is applied. This filter unit has a filter case 20 made of a resin, and a filter element installed therein and dividing the interior of the filter case 20 into a clean side S1 and a dirty side S2. The filter case 20 is configured by combining a pair of resin case elements 20A and 20B. One 20A of the case elements has an outlet pipe 21 for delivering oil to the clean side S1 and a throughhole 22 for fixing the filter case to a transmission case or the like. The other case element 20B has an inlet pipe 23 for guiding oil from the dirty side S2. Flanges 24A and 24B for connecting the case elements 20A and 20B for all the circumferences thereof are formed along the outer periphery thereof.

The filter element 30 has a filtering medium 31 formed by folding a fiber sheet described later into pleats so as to alternately arrange peaks and troughs, and a frame 32 made of a resin, provided so as to surround this filtering medium 31.

The thus configured filter unit is fixed by a bolt inserted into the throughhole 22 to an appropriate portion of the vehicle, such as the case of the automatic transmission or the vehicle body. The outlet pipe 21 is connected to an oil inlet port of the transmission (not shown), and the inlet pipe 23, to an oil discharge port of the transmission, respectively.

The filtering medium 31 according to the present invention comprises a fiber sheet containing fibers having heat resistance as typically represented by a melting temperature or a carbonization temperature of at least 300° C. This fiber is hereinafter referred to as a heat-resistant fiber.

Applicable heat-resistant fibers include a meta-type or para-type wholly aromatic polyamide fiber, a wholly aromatic polyester fiber, a polyphenylenesulfide fiber, a polyamide fiber, a polytetrafluoroethylene fiber, an aromatic polyetheramide fiber, a polybenzoimidazole fiber, glass fibers and metal fibers. From among these fibers, a wholly aromatic polyamide fiber is preferable for oxidation resistance thereof. The melting temperature is a temperature which gives a maximum value of a melting/heat absorption curve obtained by heating the fiber from room temperature at a heating rate of 10° C./minute by using a differential scanning thermal calorimeter. The carbonization temperature is a temperature obtained through thermogravimetry as specified in “JIS K 7120”.

The fiber sheet can be prepared from the above-mentioned heat-resistant fiber and any other fibers. Applicable fibers other than the heat-resistant fiber include those having a softening temperature of at least 150° C. including, for example, polyamide-based fibers, polyester-based fibers, acrylic fibers and vinylon resin fibers. From among these fibers, polyester-based fibers having the highest softening temperature are suitably applicable. Applicable fibers other than the heat-resistant fibers include cellulose-based fibers such as cotton fiber and rayon fiber. The softening temperature gives a starting point for the melting/heat absorption curve obtained by heating a material from room temperature at a heating rate of 10° C./minute by use of a differential scanning thermal calorimeter.

For the purpose of inhibiting the decrease in bursting strength of the filtering medium 31 within a practicable range, the content of the heat-resistant fiber should be at least 3 mass % of the entire fibers, or preferably, at least 5 mass %, or more preferably, at least 8 mass %.

Applicable forms of fiber sheet include non-woven fabrics, textiles, knittings and composite products thereof. Applicable non-woven fabrics include, for example, a needle punch non-woven fabric, a fluid slip non-woven fabric, a partially thermo-fused non-woven fabric, and totally thermo-fused non-woven fabric, and needle punch non-woven fabric is particularly preferable.

So as to prevent peeling and to inhibit deformation of the fiber of the fiber sheet, the fibers constituting the fiber sheet should preferably be bonded by at least a binder selected from the group consisting of rubber-based binders, thermosetting binders and thermoplastic binders. Applicable rubber-based binders include, for example, styrene-butadiene rubber (SBR), butadiene rubber (BR), isoprene rubber (IR), nitrile-butadiene rubber (NBR), chloroprene rubber, butyl rubber (IIR), urethane rubber, silicone rubber, and fluorine rubber. Applicable thermosetting binders include, for example, a phenol resin, an acrylic resin containing a crosslinking agent, an epoxy resin, a xylene resin, an urea resin, a melamine resin, and polyimide. Applicable thermoplastic binders include, for example, a ketone resin, a norbornene resin, a fluorine plastics, polyacetal, polyamine, polyamideimide, polyacrylate, thermoplastic polyimide, polyetherimide, polyetherketone, polyethyleneoxide, polyester, polyvynilidene chloride, polyvinyl chloride, polycarbonate, polyvinyl acetate, polystyrene, polysulfon, and polyvinyl alcohol.

In addition, the fiber sheet should preferably have a coarse/dense structure so as to achieve an excellent filtering property. For example, a coarse/dense structure may be available by a difference in the fiber diameter, by a difference in quantity of deposited binders, by a difference in packing ratio of fibers, or by the action of these factors. For example, when an emulsive or latex-based binder is imparted to a fiber web comprising a wholly aromatic polyamide fiber and a fiber having a high hydrophobicity than the wholly aromatic polyamide fiber (such as a polyester-based fiber), and having two or more layers having different contents of the wholly aromatic polyamide fiber, a larger amount of binder is deposited on the layer having a higher content of the wholly aromatic polyamide fiber because of the higher hydrophilicity of the wholly aromatic polyamide, thus making it possible to manufacture a filtering medium having a coarse/dense structure based on the difference in the quantity of deposited binder.

In FIG. 1, the filtering medium is manufactured by forming a fiber sheet as described above into pleats, The present invention is not however limited to this, but the fiber sheet may be formed into a flat sheet, or it is also possible to form the seam into any of various shapes.

FIG. 2 is a schematic side sectional view illustrating another embodiment of the filter element 30 and the filter unit. The filter unit also has a filter case 20 made of a resin and a filter element 30 which is attached in the filter case 20 and divides the interior thereof into a clean side S1 and a dirty side S2. The filter case 20 is configured by combining a pair of case elements 20A and 20B made of a resin. Flanges 24A and 24B are formed on the outer peripheries of the case elements 20A and 20B, respectively, for connecting them over the entire peripheries thereof. As shown in FIG. 2, the shape of the filter case 20 is changed into various ones in response to the shape of the sump case in which the filter case is housed and the attaching method.

The filter element 30 comprises only the filtering medium 31 formed by pleats-folding the fiber sheet described later so that peaks and troughs are alternately arranged, and an end of the filtering medium 31 is held between the flanges 24A and 24B of the individual case elements 20A and 20B. The configuration of the filtering medium 31 is the same as that of the filtering medium 31 shown in FIG. 1.

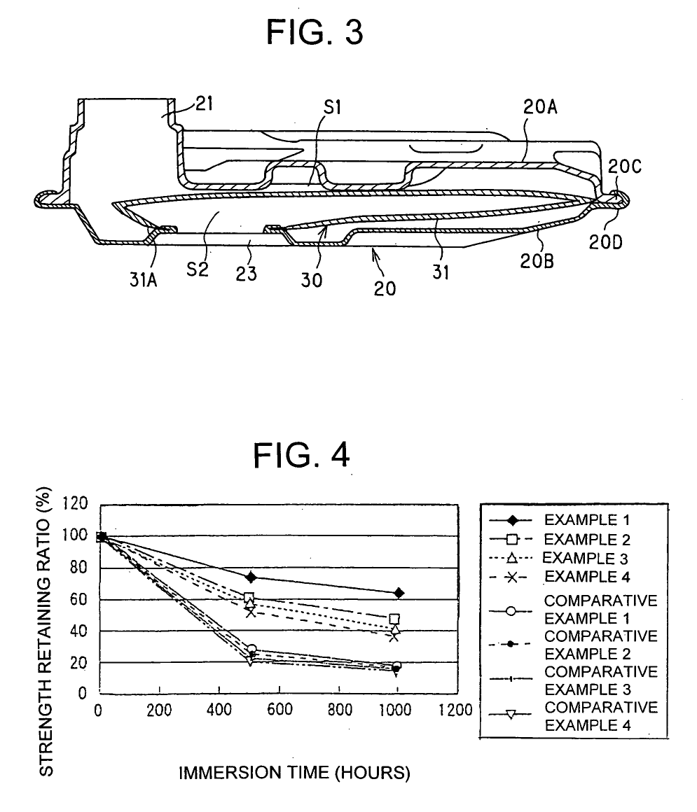

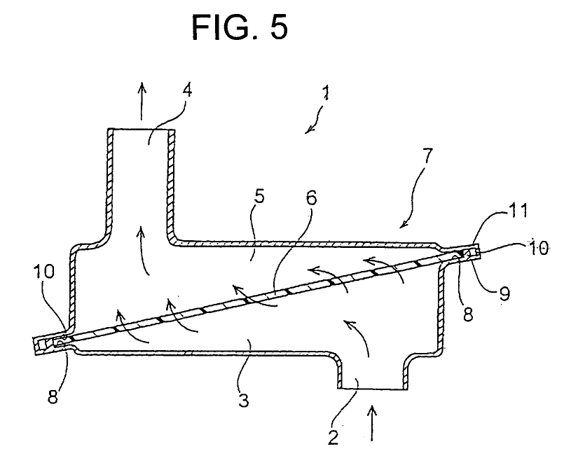

FIG. 3 is a schematic side sectional view illustrating still another examples of the filter element 30 and the filter unit. In this example, the filter case 20 comprises a combination of the case element 20A made of a resin and a case element 20B made of ion. The iron case element 20B is connected to the resin case element 20A by bonding the outer periphery 20D of the iron case element 20B, and holding the outer periphery 20C of the case element 20A by the outer periphery 20D.

The filter element 30 comprises the filtering medium 31 formed into a bag shape, and the mouth 31A of the filtering medium 31 is connected to the inlet port 23. The filtering medium 31 has the same configuration as that of the filtering medium 31 shown in FIG. 1.

The present invention will now be described further in detail by means of examples and comparative examples.

### EXAMPLE 1

As shown in Table 1, a fiber web was formed by mixing, as fibers, 30 mass % meta-type wholly aromatic polyamine fiber (fineness: 5.5 dtex, and fiber length: 76 mm; represented by “aramide 5d” in Table 1) and 70 mass % polyester fiber (fineness: 3.3 dtex, and fiber length: 51 mm; represented by “PET 3d” in Table 1) and opening the fiber mixture by means of a card machine. Then, a non-woven fabric was prepared by conducting needle punching on this fiber web with a needle density of 300 needles/cm² for the face and 300 needles/cm² for the back as shown in Table 1. Then, after spraying 50 g/m² (solid content) ester polyacrylate emulsion binder, the non-woven fabric was dried, and fibers are combined with ester polyacrylate, thereby obtaining a filtering medium having a MASS PER UNIT AREA of 250 g/m².

The bursting strength of the resultant filtering medium was measured by a Mûller bursting strength tester based on JIS P 8131. The bursting strength was measured, after the lapse of 500 hours while immersing the filtering medium in an ATF (Automatic Transmission Field) in the initial stage and keeping a temperature of 150° C., and after the lapse of 1,000 hours while immersing the filtering medium in an ATF and keeping a temperature of 150° C. The measured value of bursting strength of the filtering medium represents the ratio of strength relative to an initial value of 100, expressed as strength retaining ratio (%). The result of measurement is shown in Table 1.

### EXAMPLE 2

As shown in Table 1, a filtering medium was prepared in the same manner as in Example 1 except that 10 mass % meta-type wholly aromatic polyamide fiber (fineness: 2.2 dtex, and fiber length: 51 mm; represented by “Aramide 2d” in Table 1) and 90 mass % polyester fiber (fineness: 3.3 dtex, and fiber length: 51 mm) were mixed as fibers, and the bursting strength of the resultant filtering medium was measured. The strength retaining ratio calculated from the measured result is shown in Table 1.

### EXAMPLE 3

For the purpose of obtaining a filtering medium having a coarse/dense structure, as shown in Table 1, a fiber web (MASS PER UNIT AREA: 130 g/m²) was formed as a dense layer by mixing 10 mass % meta-type wholly aromatic polyamide fiber (fineness: 5.5 dtex, and fiber length: 76 mm) and 90 mass % polyester fiber (fineness: 3.3 dtex, and fiber length: 51 mm), and opening the resultant mixture by means of a card machine. As a coarse layer, a fiber web (MASS PER UNIT AREA: 100 g/m²) was formed by using 100 mass % polyester fiber (fineness: 6.6 dtex, and fiber length: 51 mm; represented by “PET 6d” in Table 1), and opening the mixture by means of a card machine. Then, after laminating these fiber webs, as shown in Table 1, needle punching was carried out with a needle density of 150 needles/cm² for the face (on the dens layer fiber web side) and a needle density of 150 needles/cm² for the back (on the coarse layer fiber web side), thereby forming a non-woven fabric. Then, after spraying an ester polyacrylate emulsion binder onto this non-woven fabric and drying the same (solid content: 15 g/m²), the non-woven fabric was immersed in a phenol resin emulsion binder and dried (45 g/m² (solid content)). Fibers were combined with these binders to obtain a filtering medium having a MASS PER UNIT AREA of 250 g/m². The bursting strength of the resultant filtering medium was measured in the same manner as in the above-mentioned Examples. The strength retaining ratio calculated from the measured result is shown in Table 1.

### EXAMPLE 4

As shown in Table 1, a fiber web was formed by mixing, as fibers, 10 mass % meta-type wholly aromatic polyester fiber (fineness: 5.5 dtex, and fiber length: 76 mm), 50 mass % polyester fiber (fineness: 3.3 dtex, and fiber length: 51 mm), and 40 mass % polyester fiber (fineness: 6.6 dtex, and fiber length: 51 mm), and opening the mixture by means of a card machine. Then, the resultant fiber web was subjected to needle punching with a needle density of 300 needles/cm² for the face and a needle density of 300 needles/cm² for the back, thereby forming a non-woven fabric. Then, after spraying an ester polyacrylate emulsion binder and drying the same (solid content: 15 g/m²), the non-woven fabric was immersed into a phenol resin emulsion binder and dried (20 g/m² (solid content)) to combine fibers with these binders, thereby obtaining a filtering medium having a MASS PER UNIT AREA of 235 g/m². The bursting strength of the resultant filtering medium was measured in the same manner as in the above-mentioned Examples. The strength retaining ratio calculated from the measured result are shown in Table 1.

TABLE 1

| ITEM | | EXAMPLE 1 | | | EXAMPLE 2 | | | EXAMPLE 3 | | | |
|---|---|---|---|---|---|---|---|---|---|---|---|
| MASS PER UNIT AREA | g/m² | 250 | | | 250 | | | 290 | | | |
| THICKNESS | mm | 1.8 | | | 2.0 | | | 1.5 | | | |
| FIBER | RATIO | PET3d | 70% | 200 | PET3d | 90% | 200 | DENSE | PET3d | 90% | 130 |
| | | ARAMIDE5d | 30% | | ARAMIDE2d | 10% | | LAYER | ARAMIDE5d | 10% | |
| | | | | | | | | COARSE | PET6d | 100% | 100 |
| | | | | | | | | LAYER | | | |

| | | | | | | | |
|---|---|---|---|---|---|---|---|
| BINDER | g/m² | ESTER | 50 | ESTER | 50 | ESTER POLYACRYLATE | 15 |
| | | POLYACRYLATE | | POLYACRYLATE | | | |
| | | | | | | PHENOL RESIN | 45 |

| NEEDLE DENSITY | | NEEDLES/ | FACE: 300, BACK: 300 | FACE: 300, BACK: 300 | FACE: 150, BACK: 150 |
|---|---|---|---|---|---|
| | | cm² | | | |
| BURSTING | 0 HR. | STRENGTH | 100 | 100 | 100 |
| STRENGTH | 500 HRS. | RETAINING | 75 | 59 | 58 |
| | 1000 HRS. | RATIO (%) | 65 | 48 | 42 |

| ITEM | | EXAMPLE 4 | | |
|---|---|---|---|---|
| MASS PER UNIT AREA | g/m² | 235 | | |
| THICKNESS | mm | 1.8 | | |
| FIBER | RATIO | PET6d | 40% | 200 |
| | | PET3d | 50% | |
| | | ARAMIDE5d | 10% | |

| | | | |
|---|---|---|---|
| BINDER | g/m² | ESTER | 15 |
| | | POLYACRYLATE | |
| | | PHENOL RESIN | 20 |

| NEEDLE DENSITY | | NEEDLES/ | FACE: 300, BACK: 300 |
|---|---|---|---|
| | | cm² | |
| BURSTING | 0 HR. | STRENGTH | 100 |
| STRENGTH | 500 HRS. | RETAINING | 52 |
| | 1000 HRS. | RATIO (%) | 44 |

### COMPARATIVE EXAMPLE 1

As shown in the following Table 2, a filtering medium was prepared in the same manner as in Example 1 except that polyester film (fineness: 3.3 dtex, and film length: 51 mm) was used as a fiber in an amount of 100 mass %, and the bursting strength of the resultant filtering machine was measured. The strength retaining ratio calculated from the measured result are shown in Table 2.

### COMPARATIVE EXAMPLE 2

As shown in Table 2, a filtering medium was prepared in the same manner as in Example 2 except that polyester fiber (fineness: 6.6 dtex, and fiber length: 51 mm) was used as a fiber in an amount of 100 mass %, and the bursting strength of the resultant filtering medium was measured. The strength retaining ratio calculated from the measured result is shown in Table 2.

### COMPARATIVE EXAMPLE 3

As shown in Table 2, a filtering medium was prepared in the same manner as in Example 3 except that polyester fiber (fineness: 6.6 dtex, and fiber length: 51 mm) was used as a dense layer in an amount of 100 mass % and polyester fiber (fineness: 6.6 dtex, and fiber length: 51 mm) was used as a coarse layer, and the bursting strength of the resultant filtering medium was measured. The strength retaining ratio calculated from the measured result is shown in Table 2.

### COMPARATIVE EXAMPLE 4

As shown in Table 2, a filtering medium was prepared in the same manner as in Example 4 except that polyester fiber (fineness: 6.6 dtex, and fiber length: 51 mm) was used as a fiber in an amount of 50 mass % and polyester fiber (fineness: 3.3 dtex, and fiber length: 51 mm) was used as a fiber in an amount of 50 mass %, and the bursting strength of the resultant filtering medium was measured. The strength retaining ratio calculated from the measured result is shown in Table 2.

TABLE 2

| | | COMPARATIVE | | | COMPARATIVE | | | COMPARATIVE | | | |
|---|---|---|---|---|---|---|---|---|---|---|---|
| ITEM | | EXAMPLE 1 | | | EXAMPLE 2 | | | EXAMPLE 3 | | | |
| MASS PER UNIT AREA | g/m² | 250 | | | 250 | | | 290 | | | |
| THICKNESS | mm | 1.8 | | | 2.0 | | | 1.5 | | | |
| FIBER | RATIO | PET3d | 100% | 200 | PET6d | 100% | 200 | DENSE LAYER | PET3d | 100% | 130 |
| | | | | | | | | COARSE LAYER | PET6d | 100% | 100 |

| | | | | | | | |
|---|---|---|---|---|---|---|---|
| BINDER | g/m² | ESTER | 50 | ESTER | 50 | ESTER | 15 |
| | | POLYACRYLATE | | POLYACRYLATE | | POLYACRYLATE | |
| | | | | | | PHENOL RESIN | 45 |

| NEEDLE DENSITY | | NEEDLES/ | FACE: 300, BACK: 300 | FACE: 300, BACK: 300 | FACE: 150, BACK: 150 |
|---|---|---|---|---|---|
| | | cm² | | | |
| BURSTING | 0 HR. | STRENGTH | 100 | 100 | 100 |
| STRENGTH | 500 HRS. | RETAINING | 22 | 25 | 28 |
| | 1000 HRS. | RATIO (%) | 16 | 18 | 19 |

| | | COMPARATIVE | | |
|---|---|---|---|---|
| ITEM | | EXAMPLE 4 | | |
| MASS PER UNIT AREA | g/m² | 235 | | |
| THICKNESS | mm | 1.8 | | |
| FIBER | RATIO | PET6d | 50% | 200 |
| | | PET3d | 50% | |

| | | | |
|---|---|---|---|
| BINDER | g/m² | ESTER | 15 |
| | | POLYACRYLATE | |
| | | PHENOL RESIN | 20 |

| NEEDLE DENSITY | | NEEDLES/ | FACE: 300, BACK: 300 |
|---|---|---|---|
| | | cm² | |
| BURSTING | 0 HR. | STRENGTH | 100 |
| STRENGTH | 500 HRS. | RETAINING | 28 |
| | 1000 HRS. | RATIO (%) | 19 |

The relationship between the ATF immersion time and the strength retaining ratio in the above-mentioned examples 1 to 4 and Comparative examples 1 to 4 is illustrated in FIG. 4. As is clear from FIG. 4, the bursting strength seriously decreases in the filtering media of Comparative Examples after the lapse of 500 hours after immersing in the ATF at 150° C. In the filtering media of Examples, in contrast, a favorable result of a smaller decrease in bursting strength was obtained. This reveals that the filtering medium of the present invention can keep a bursting strength on a practicable level.

In the above-mentioned embodiments, the cases shown in FIGS. 1 to 3 have been described as the filtering media of the present invention. However, the present invention is not limited to these cases, but is applicable to filters of various other shapes and similarly applicable to automatic transmissions of various types, providing the same advantages as above.

According to the present invention, as described above, since the filtering medium comprises a fiber sheet containing a heat-resistant fiber, of which the melting temperature or the carbonization temperature is at least 300° C., the filtering medium can maintain a practical bursting strength.

According to a preferred embodiment of the present invention, since the above-mentioned fiber is wholly aromatic polyamide fiber, the strength is hardly reduced by an acid, and the fiber remains to be a suitable heat-resistant fiber, with a slighter decrease in bursting strength, thus giving a satisfactory filtering medium.

According to a preferred embodiment of the present invention, since the fiber accounts for 3 mass % or more of the entire fibers constituting the fiber sheet, there is available a filtering medium of which the bursting strength is hardly decreased by heat.

According to a preferred embodiment of the present invention, since the fiber sheet has a coarse/dense structure, a filtering medium excellent in filtering property is obtained.

According to a preferred embodiment of the present invention, since fibers constituting the fiber sheet are bonded by at least a kind of binder selected from a group consisting of rubber-based binders, thermosetting binders, and thermoplastic binders, the fiber is not easily peeled off or deformed.

According to a preferred embodiment of the present invention, since the fiber sheet has an area having a large deposit quantity of the binder and an area having a small deposit quantity of the binder, a coarse/dense structure is formed, and the filtering property of the filtering medium is further improved.

1. A filtering medium of an oil filter for automatic transmission, comprising:
a fiber sheet containing a heat-resistant fiber, of which the melting temperature or the carbonization temperature is at least 300° C.

2. The filtering medium according to claim 1, wherein said fiber is wholly aromatic polyamide fiber.

3. The filtering medium according to claim 1 or 2, wherein said fiber accounts for 3 mass % or more of the entire fibers constituting said fiber sheet.

4. The filtering medium according to any one of claims 1 to 3, wherein said fiber sheet has a coarse/dense structure.

5. The filtering medium according to any one of claims 1 to 4, wherein fibers constituting said fiber sheet are bonded by at least a kind of binder selected from a group consisting of rubber-based binders, thermosetting binders, and thermoplastic binders.

6. The filtering medium according to claim 5, wherein said fiber sheet has an area having a large deposit quantity of said binder and an area having a small deposit quantity of said binder.
